(19) United States
(12) Patent Application Publication
(10) Pub. No.: US 2026/0080338 A1
(43) Pub. Date: Mar. 19, 2026

(54) METHOD AND SYSTEM TO DYNAMICALLY DETERMINE DESIGN PRINCIPLES TO IDENTIFY AND OPTIMIZE CARBON SPEND IN ENTERPRISES

(71) Applicant: INTERNATIONAL BUSINESS MACHINES CORPORATION, Armok, NY (US)

(72) Inventors: Charbak Roy, Kolkata (IN); Jignesh Karia, Thane (IN); Anubhav Kothari, Bangalore (IN); Joydeep Gupta, Kolkata (IN); Vijay Kumar Tripathi, Noida (IN)

(21) Appl. No.: 18/884,909

(22) Filed: Sep. 13, 2024

(51) Int. Cl. G06Q 10/0637

(52) U.S. Cl. CPC G06Q 10/0637

(57) ABSTRACT

Systems and methods are disclosed herein for optimizing carbonization benefit based on sustainability design principles. A method for optimizing carbonization benefit based on sustainability design principles reading a plurality of sustainability design principles associated with an organization; assigning each sustainability design principle of the plurality of sustainability design principles to one of a plurality of IT categories; computing, based on the design principles assigned to each IT category, a percentage carbon footprint for each of the plurality of sustainability design principles and for each of the IT categories; selecting, based on the computed percentage carbon footprints for each of the IT categories, a most impactful IT category; generating a sorted priority list of sustainability design principles within the most impactful IT category; and recommending an action plan to maximize carbonization benefit to the organization based on the sorted priority list of carbon footprint savings.

### TECHNICAL FIELD

Embodiments of the present disclosure are related to a system, method, and computer program product for designing green IT technology used for reduced carbon emissions.

### BACKGROUND OF THE DISCLOSURE

To bolster Green IT efforts, there is a need to adopt various Green IT Design Principles to reduce carbon emission from business implementation and operations activities. While these design principles provide a prescriptive way of designing and operating IT systems to reduce a carbon footprint, currently there is no guidance available for organizations to determine which of these principles may provide the highest amount of carbon benefits. In the absence of such quantified guidance, sustainability leads in various organizations struggle to identify the most impactful design principle that the rest of the organization needs to actionize.

Accordingly, there is a need to dynamically determine design principles that yield the highest decarbonization benefits.

### SUMMARY

Here, a method is proposed to identify and define a technique for dynamically determining design principles to yield a maximum carbonization benefit.

In an embodiment, a method comprises for optimizing carbonization benefit based on sustainability design principles, the method comprising: reading a plurality of sustainability design principles associated with an organization; assigning each sustainability design principle of the plurality of sustainability design principles to one of a plurality of IT categories; computing, based on the design principles assigned to each IT category, a percentage carbon footprint for each of the plurality of sustainability design principles and for each of the IT categories; selecting, based on the computed percentage carbon footprints for each of the IT categories, a most impactful IT category; generating a sorted priority list of sustainability design principles within the most impactful IT category; and recommending an action plan to maximize carbonization benefit to the organization based on the sorted priority list of carbon footprint savings.

In an alternative embodiment, a system for optimizing carbonization benefit based on sustainability design principles comprises a computing node comprising a computer readable storage medium having program instructions embodied therewith, the program instructions executable by a processor of the computing node to cause the processor to perform a method comprising: reading a plurality of sustainability design principles associated with an organization; assigning each sustainability design principle of the plurality of sustainability design principles to one of a plurality of IT categories; computing, based on the design principles assigned to each IT category, a percentage carbon footprint for each of the plurality of sustainability design principles and for each of the IT categories; selecting, based on the computed percentage carbon footprints for each of the IT categories, a most impactful IT category; generating a sorted priority list of sustainability design principles within the most impactful IT category; and recommending an action plan to maximize carbonization benefit to the organization based on the sorted priority list of carbon footprint savings.

In an alternative embodiment, a computer program product for optimizing carbonization benefit based on sustainability design principles, the computer program product comprising a computer readable storage medium having program instructions embodied therewith, the program instructions executable by a processor to cause the processor to perform a method comprising: reading a plurality of sustainability design principles associated with an organization; assigning each sustainability design principle of the plurality of sustainability design principles to one of a plurality of IT categories; computing, based on the design principles assigned to each IT category, a percentage carbon footprint for each of the plurality of sustainability design principles and for each of the IT categories; selecting, based on the computed percentage carbon footprints for each of the IT categories, a most impactful IT category; generating a sorted priority list of sustainability design principles within the most impactful IT category; and recommending an action plan to maximize carbonization benefit to the organization based on the sorted priority list of carbon footprint savings.

### BRIEF DESCRIPTION OF THE DRAWINGS

The accompanying drawings, which are incorporated into and constitute a part of this specification, illustrate various exemplary embodiments and together with the description, serve to explain the principles of the disclosed embodiments.

FIG. 1 is a schematic illustrating a series of exemplary Green IT Design Principles, in accordance with one or more embodiments of this disclosure.

FIG. 2 is a flowchart of an exemplary method for dynamically determining design principles to yield a maximum carbonization benefit, in accordance with one or more embodiments of this disclosure.

FIG. 3 is an exemplary workflow for a method of identifying Green IT actions, in accordance with one or more embodiments of this disclosure.

FIG. 4 is an illustration of exemplary buckets for dividing sustainability principles, in accordance with one or more embodiments of this disclosure.

FIG. 5 is a schematic illustrating an exemplary bucket with design principles, in accordance with one or more embodiments of this disclosure.

FIG. 6 is a chart comparing carbon benefits, in accordance with one or more embodiments of this disclosure.

FIG. 7 is an exemplary computing node.

### DETAILED DESCRIPTION

Reference will now be made in detail to the exemplary embodiments of the present disclosure, examples of which are illustrated in the accompanying drawings. Wherever possible, the same reference numbers will be used through-out the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as man-datory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

Green information technology (IT) is the practice of creating and using environmentally sustainable computing resources. Green IT aims to minimize negative effects of IT operations on the environment by designing, manufacturing, operating and disposing of servers, PCs and other computer-related products in an environmentally friendly manner. These negative effects may be based on the amount of electricity and carbon output required to operate IT. Organizations may be motived to use Green IT products to decrease their carbon footprints and thereby to decrease greenhouse gas emissions, as compared to use by traditional IT products and operations.

Organizations set their Net Zero targets based on environmental, social, and governance (ESG) guidelines. In order to achieve those targets, these organizations need to take various decarbonization initiatives. As part of many decarbonization initiatives, organizations need to adopt Green IT Design Principles in their transformation and operations activities. Generally, organizations take an incremental and iterative approach and apply the most impactful principles first. Currently there is no guidance available for organizations to determine which principles may provide highest amount of decarbonization benefits, within each's context. Embodiments of the present disclosure help organizations to determine impactful principles in a scientific fashion.

Accordingly, embodiments of the present disclosure include methods and systems to dynamically determine design principles that yield a highest energy savings. These may include futuristic projections of energy consumption based on the applicability of design principles and associated workload characteristics. For example, workload characteristics may include high input/output intensive workloads and high compute intensive workloads. Some workloads, such as memory intensive workloads, may require different levels of resource consumption and will impact a method of identifying a most impactful bucket associated with some design principles. In some embodiments, the method and system may include a recommendation for an automated energy optimization for a transformation initiative by dynamic factoring of design principles.

Some embodiments of the present disclosure include methods and systems for determining a right energy aware design based on existing application usage data and design patterns to ensure the right energy efficient principles are being chosen based on workload characteristics. This may include determining energy saving metrics derived from a historical behaviors of resource consumption. Historic data may provide trends and patterns while calculating a most impactful bucket associated with design principles, although it is contemplated that design principles underneath the historical data may change.

In some embodiments, methods and systems may verify a reasonable decision of an infrastructure provisioning based on carbon footprint using a statistical model. This may include comparing all possible alternative feasible options based on a futuristic carbon emission trend to determine which design principles to choose. The same formulation may be applied to future decisions of procuring new hardware, storage, and network equipment to thereby make decisions.

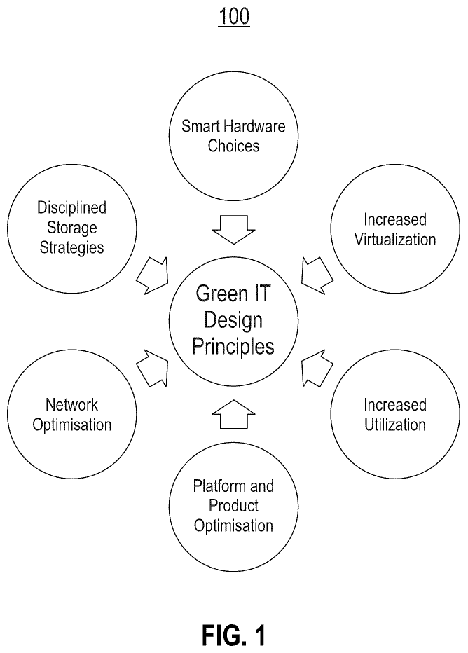

FIG. 1 is a number of Green IT Design Principles that may be included in various embodiments of the present disclosure. These principles include, but are not limited to disciplined storage strategies, smart hardware choices, increased virtualization, increased utilization, platform and product optimization, and network optimization.

To help identify and define a technique for green design principles, embodiments of the present disclosure help organizations identify an amount of carbon benefits that may be achieved by adopting these principles. A general approach may be broken down into a series of steps, where a first step comprises dividing a principle into three separate buckets of Compute, Network, and Storage. In a second step, one bucket is identified as the most impactful based on an organization's footprint of resources from the three separate buckets. In a third step, and from the identified “most impactful” bucket, each design principle is further dissected to arrive at a percentage carbon reduction if dedicated effort is spent towards that principle. In a fourth step, a sorted list of principles to be prioritized by the organization towards carbon reduction is defined based on a carbon reduction footprint in each area.

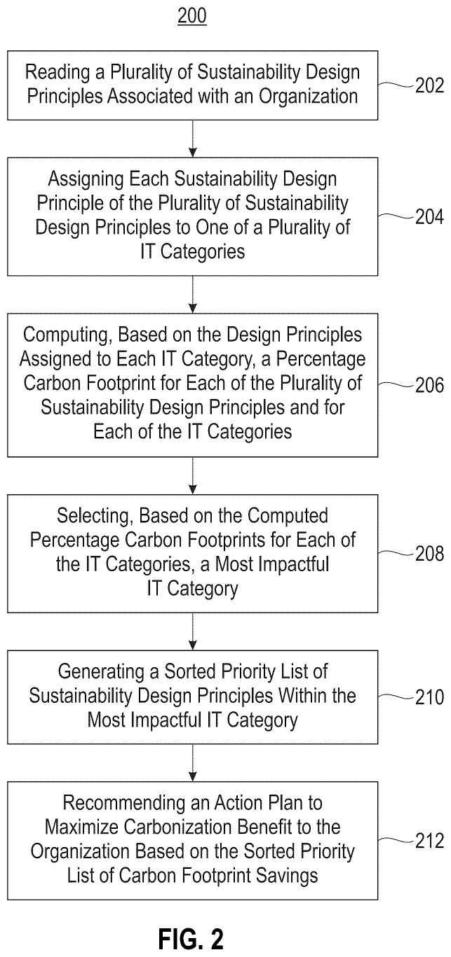

FIG. 2 is a flowchart of an exemplary method 200 for dynamically determining design principles to yield a maximum carbonization benefit. Method 200 (i.e., steps 202-212) may be performed automatically or in response to a request by a user.

In step 202, the method may include reading a plurality of sustainability design principles associated with an organization. Design principles may be catered to the fundamental building blocks of the organization's IT landscape. In some embodiments, the design principles may be predetermined by an organization's sustainability lead. In some embodiments, the design principles may be determined by historical trends. In some embodiments, the design principles may be based on the organization's IT landscape.

In step 204, the method may include assigning each sustainability design principle of the plurality of sustainability design principles to one of a plurality of IT categories. In the illustrated embodiment, the IT categories comprise compute, storage, and network. In other embodiments, the IT categories may differ based on an organization's IT footprint. For example, an organization dealing primarily with internet of things (IOT) devices may have IOT related design principles and IT categories. Organizations may identify IT categories, as well as design principles, based on existing IT asset data.

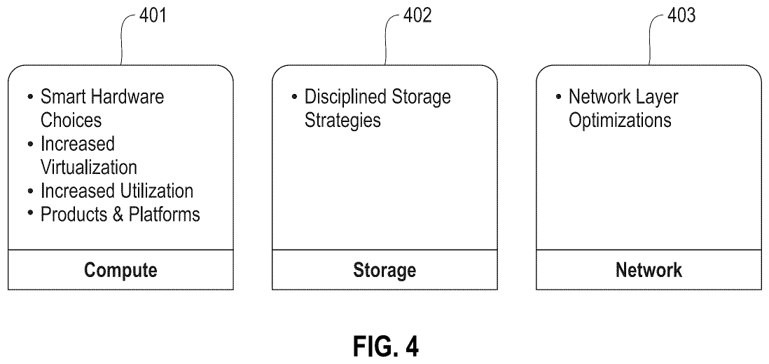

Assigning each sustainability design principle to IT category may be based on pre-existing tagging, as depicted in FIG. 4. Assignments can further be extended and/or tailored based on an organization's carbon footprint. For example, an organization dealing with large number of IOT devices can add IOT design principles either in an existing IT category or create a new IT category.

In step 206, the method may include computing, based on the design principles assigned to each IT category, a percentage carbon footprint for each of the plurality of sustainability design principles and for each of the IT categories. Each design principle may be associated with an associated computation mechanism or algorithm. For example, a computation mechanism associated with “increased virtualization” may be different from a computation mechanism associated with “increased utilization.”

In step 208, the method may include selecting, based on the computed percentage carbon footprints for each of the IT categories, a most impactful IT category. Each percentage carbon footprint may be based on an absolute carbon saving percentages.

In step 210, the method may include generating a sorted priority list of sustainability design principles within the most impactful IT category. The sorted priority list may include second order considerations. Second order considerations may include, but are not limited to: organization goals; an amount of effort required to implement specific design principles; other ongoing initiatives within the organization; and other long term organization plans.

In step 212, the method may include recommending an action plan to maximize carbonization benefit to the organization based on the sorted priority list of carbon footprint savings.

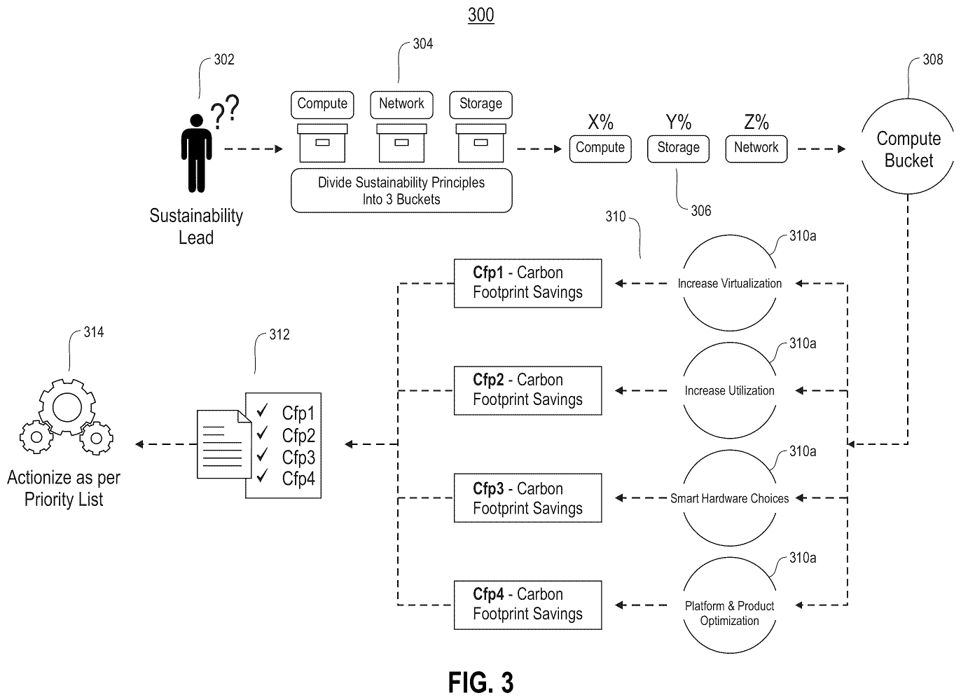

FIG. 3 is an exemplary workflow illustrating a method 300 for determining identifying a sorted priority list based on an order of carbon savings. In the method 300, a sustainability lead 302 struggles to identify the most impactful design principle that the rest of the organization needs to actionize. Often, sustainability leads 302 are confused on where to start or which sustainability practice is the most beneficial. To address these concerns, in step 304 the sustainability principles considered by the organization are divided into three buckets. Buckets may include a “compute” bucket, a “network” bucket, and a “storage” bucket, or any other bucket deemed suitable for the organization. It is contemplated that there may be more than three buckets in some embodiments of method 300, to account for additional sustainability principles. As shown in FIG. 4, the compute bucket may include principles such as increase virtualization, increase utilization, smart hardware choices, and platform and product optimizations. The storage bucket may include principles such as disciplined storage strategies. The network bucket may include principles such as network optimization.

In step 306, a bucket is identified as the most impactful based on organization footprint of resources in each bucket. The impact may be represented by a percentage of resources, as shown in FIG. 3, where X % is associated with the compute bucket, Y % is associated with the storage bucket, and Z % is associated with the network bucket, such that the X, Y, and Z percentages added together equal 100%. The largest percentage bucket is the most impactful on the organization. Table 1 below illustrates an exemplary breakdown of how the most impactful bucket is identified.

TABLE 1
Identifying the most impactful bucket

| | Data Centre Distribution based on |
|---|---|
| Bucket | Carbon Emission* |
| Compute | Cₜᵢ % |
| Storage | Sₜᵢ % |
| Network | Nₜᵢ % |

Assuming Cᵢ % of carbon improvement effort is performed for each of the buckets, the maximum amount of carbon benefit is derived using the equation below. The bucket with the maximum amount of carbon benefit is referred to as the Most Impactful Bucket.

$$Most Impactful Bucket\_ = MAX ( ( Compute Estate \% * Carbon Improvement effort \% ) ,$$

$$( ( ( Storage Estate \% * Carbon Improvement effort \% ) ,$$

$$( ( ( Network Estate \% * Carbon Improvement effort \% ) )$$

$$MIB = MAX ( ( {C}_{ti} \% * {C}_{i} \% ) , ( {S}_{i} \% * {C}_{i} \% ) , ( {N}_{i} \% * {C}_{i} \% ) )$$

Based on the above computations, the bucket providing largest carbon benefits may be prioritized for action to achieve faster decarbonization benefits. It should be noted that Cₙ % consists of historical patterns, not instance values.

In step 308, the identified bucket is dissected and all principles are listed down from the bucket. This dissection is used to calculate an estimated carbon footprint based on an algorithm applied to each design principle of the identified most impactful bucket shortlisted in step 306.

In step 310, the principles (shown as principles 310a-310d) listed down from the computed bucket of step 304 are associated with a carbon footprint savings value (Cfp 1-4, where principle 310a is associated with Cfp1, principle 310b is associated with Cfp2, etc.).

In step 312, the carbon footprint savings values (i.e., Cfp1-4) are sorted based on a descending order of carbon savings. The resulting sorted priority list shows the most impactful principle within the computed bucket.

In step 314, the priority list is actionized, in order of descending carbon savings. It is contemplated that the steps of method 300 can be repeated in multiple iterations within the net zero target journey of an organization.

FIG. 4 illustrates the Green IT Principles sorted into one of three buckets, corresponding to compute, storage, and network ideas. The compute bucket 401 may comprise principles such as smart hardware choices, increased virtualization, increased utilization, and products and platforms associated with greener computing outputs. The storage bucket 402 may comprise disciplined storage strategies. The network bucket 403 may comprise network layer optimization. It is contemplated that additional principles may be sorted into each bucket.

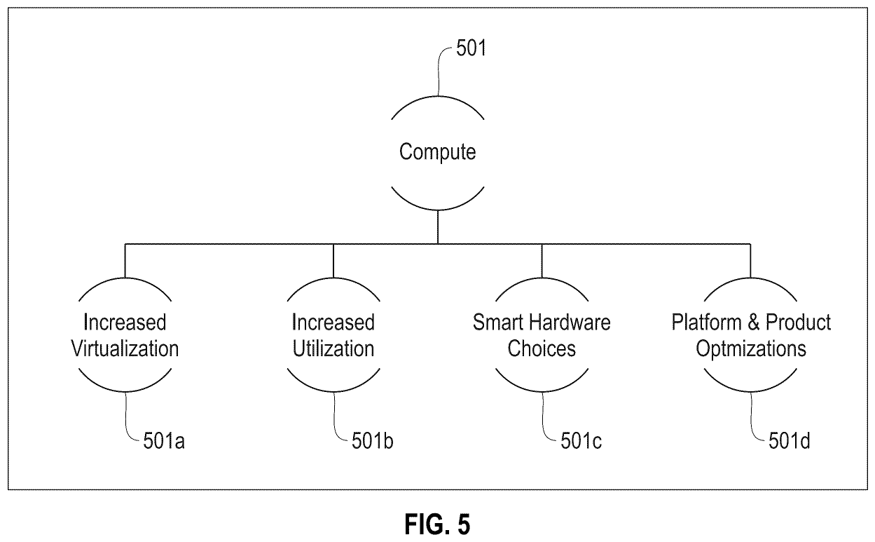

FIG. 5 illustrates the dissection of an impact bucket 501. Here, the impact bucket 401 comprises the compute bucket, holding a series of principles 501a-501d. In most organizations, the “compute” principles contribute at the highest rate to the carbon footprint. However, additional dissection as outlined in step 308 of method 300 helps to identify a specific principle providing maximum benefits. A breakdown of the impact principles and their associated carbon efficiency follows below.

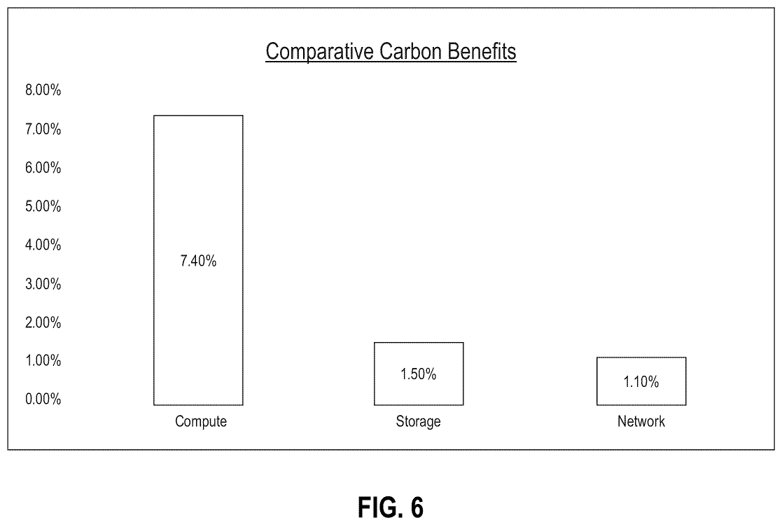

FIG. 6 is a graph illustrating the comparative carbon benefits from each bucket. It may be easily seen that the highest carbon benefit results from the compute bucket. Assuming efforts are spent in these areas to reduce the carbon footprint, corresponding absolute benefits are calculated. Since the compute bucket constitutes a larger percentage of data center estate, mathematically it would mean any effort spent in the compute bucket would yield ‘Higher Absolute’ Carbon benefits as compared to storage and network. A breakdown is shown in Table 2.

TABLE 2
Benefits per Bucket

| | Data Centre | | |
|---|---|---|---|
| | Distribution on an | | |
| | average based on | Example | Proportionate |
| Bucket | Carbon Emission* | Reduction | Benefits |
| Compute | 74% | 10% | 7.40% |
| Storage | 15% | 10% | 1.50% |
| Network | 11% | 10% | 1.10% |

Bucket Impact on Footprint (BIF) is calculated using the following equation:

$$BIF = Max ( 7.4 \% , 1.5 \% , 1.1 \% ) = 7.4 \%$$

Hence, the compute bucket may be prioritized for this organization to achieve maximum carbon benefits.

### Impact Principle 1: Virtualization

Virtualization has the following principle levers.

1) Overcommitment Ratio (OCMr): CPU overcommitment means running more vCPUs on a host than the total number of underlying physical processor cores in that host. Most virtualization software enable server teams to enable CPU overcommitment, without impacting virtual machine performance. Overcommitment ratios of 2 or 3 are very common in software industry. The assumption is made that OCMr factor for organization is M.

2) Number of Virtualized servers hosted per Physical Server: Virtualized systems are generally built on large sized underlying physical hosts. This in turn enables a server team to fulfill the same amount of compute capacity through a lesser number of physical servers as compared to BareMetal servers. Fewer physical servers results in a lesser amount of energy usage. It is also important to note that there is a non-linear correlation between the number of cores in a server and the corresponding carbon footprint of server. A server carbon footprint tends to straighten out beyond a threshold point and doesn't increase linearly.
Carbon Footprint of L Core Server—1 C_{fp} KW
Carbon Footprint of 2 L Core Server—1.3 C_{fp} KW.
Carbon Footprint of 10 L Core Server—2 C_{fp} KW

Assuming that, for an organization, an application team has requested Y_{c} cores of Compute capacity for the application. Using the equation below, the effective Carbon footprint when this capacity is addressed through virtualization is gauged as compared to through Bare Metal servers.

3) Virtualization Overhead (Vₒₕ %): Virtualization software introduces a trivial amount of overhead on the overall compute capacity.

To determine the impact of virtualization on the carbon footprint, the carbon footprint is calculated by running a workload on BareMetal serves compared to running the same workload on a virtual machine. These carbon footprint numbers can be used to perform a quantitative comparison of running workloads on BareMetal servers vs. virtual machines.

To calculate the capacity addressed through BareMetal servers, the core capacity requirement of Y_{c} cores is addressed through Bare Metal servers (assuming servers of mixed sizes—Half servers of L_{c} cores & other half of 2 L_{c} cores only). This can be represented through the below equation:

$$Total Carbon Footprint ( BMs ) = ( ( ( Y / 2 / {L}_{c} ) \times ( 1 {C}_{fp} ) ) + ( ( Y / 2 / 2 {L}_{c} ) \times ( 1.3 {C}_{fp} ) ) ) KW$$

where Y is the total compute core capacity, and C_{fp} is the carbon footprint of server.

To calculate the capacity addressed through virtual machines, the core capacity requirement of Y_{c} cores is addressed through VMs that are hosted on large sized physical servers (assuming servers of size 10 L_{c} cores only). Considering the overcommitment factor of M, the effective compute capacity required is equal to Y/M. The total carbon footprint is calculated using the below equation:

$$Total Carbon Footprint ( VMs ) = ( ( [ Y + \{ Y \times {V}_{oh} \} ] / M / 10 {L}_{c} ) \times ( 2 {C}_{fp} ) ) KW$$

where Y is the total compute core capacity, Vₒₕ is the virtualization overhead, M is the overcommitment factor, and C_{fp} is the carbon footprint of server.

### Impact Principle 2: Increase Utilization

Based on an average utilization of servers in a datacenter and the maximum utilization that is safely acceptable to the organization's SLA, the Green IT goal is to identify carbon savings in case utilization is increased by right-sizing resources. To calculate the carbon savings, the following equation is used:

$$Carbon Savings ( KW ) = ( ( {MAU}_{i} - A {U}_{i} ) * {Y}_{c} ) \times ( {C}_{cfp} ) ) KW$$

Here, the Average DC Utilization (AUᵢ) is the average utilization of servers at the organization's data center location measured over a period, e.g., 20% utilization. The maximum acceptable DC Utilization (MAUᵢ) is the maximum utilization of servers at the organization's data center location, which is safely acceptable to the organization's business, e.g., 70% threshold. The overall compute capacity of the datacenter location is represented by Y_{c}. The carbon footprint per core is represented by C_{cfp}. Through focused efforts, organizations may target to increase their AUᵢ to bring it closer to MAUᵢ to ensure the most optimum utilization of available resources.

### Impact Principle 3: Smart Hardware Choices

The goal related to using smart hardware is to identify an amount of carbon savings by running a workload on a next-generation server as compared to a previous generation server. Newer generation servers provide higher compute capacity per core compared to previous generation servers. This effectively means the same amount of throughput can be achieved through fewer cores of newer generation servers compared to old generation servers. In the below equation, an overall compute capacity required for Data Center location is represented by Y_{c}. The NextGen Compute Efficiency factor (NGC_{f}) represents the compute efficiency offered by new generation servers compared to previous generation servers. Carbon Footprint per core is represented by C_{cfp}.

$$Carbon Savings ( KW ) = ( {Y}_{c} * {NGC}_{f} ) * ( {C}_{cfp} ) ) KW$$

### Impact Principle 4: Platform and Product Choices

Here, the aim is to identify an amount of carbon savings by reducing server idling time. This is particularly important for cases of Test & Development (Dev) environment, keeping the environment up during business hours only and shutting it down after business hours, weekends and holidays. To identify the carbon savings, the energy consumption in both the cases and corresponding savings is determined by adopting server shutdown. The overall server capacity required for the Test & Dev environment may be represented by N_{T&D} and the carbon footprint per KW of energy may be represented by C_{kw}.

In a first scenario (“Scenario A”), the Test & Dev VMs remain up throughout the year. Utilization is computed during Testing hours (Business Hours T_{H}), at 6x %. The energy consumption is measured at 6x % server utilization (During Business Hours T_{H}), and represented as E_{6xc} W. Utilization is further calculated during non-Testing hours (Non-Business Hours NT_{H}) at 2x %. The energy consumption at 2x % server utilization is represented by E_{2xc} W.

$$\underline{A} - Scenario A Energy Consumption / Yr ( KW ) = \text{} \text{} [ \text{} ( {N}_{T \& D} * {T}_{H} * {E}_{6 xc} ) + ( ( {N}_{T \& D} * {NT}_{H} * {E}_{2 xc} ) ] / 1000 KW$$

In a second scenario (“Scenario B”), the Test & Dev VMs are deflated (shut down) during non-business hours. Utilization is computed during Testing hours (Business Hours T_{H}), at 6x %. The energy consumption is measured at 6x % server, and represented as E_{6xc} W. Utilization is further calculated during non-Testing hours (Non-Business Hours NT_{H}) at x %. The energy consumption at 6x % server utilization is represented by E_{2xc} W.

Accordingly, the carbon footprint of Scenario B is calculated as outlined below.

$$Carbon Footprint Savings achieved with Scenario B ( KG ) = ( A - B ) ⋆ ( {C}_{k w} ) KG$$

Carbon footprint savings are calculated using:

$$Carbon Footprint Savings achieved with Scenario B ( KG ) = ( \{ [ {N}_{T \& D} * {T}_{H} * {E}_{6 xc} ) + ( ( {N}_{T \& D} * {NT}_{H} * {E}_{2 xc} ) ] / 1000 \} - \{ [ {N}_{T \& D} * {T}_{H} * {E}_{6 xc} ) + ( ( {N}_{T \& D} * {NT}_{H} * {E}_{xc} ) ] / 1000 \} ) * ( {C}_{kw} )$$

The total carbon footprint may be represented by the following equation:

$$Total Carbon Footprint = Total Energy consumed by IT equipment X Power Usage Effectiveness ( PUE ) X Carbon Intensity ( CI ) of the Grid .$$

In this example, the PUE and CI are assumed to be same in both scenarios (i.e., scenario A as well as B). In scenario B, equipment is kept up only for a limited period, while in scenario A, the same equipment is kept up for 24 hours a day, seven days a week. Hence, the lesser energy consumed in scenario B leads to more carbon savings for the organization.

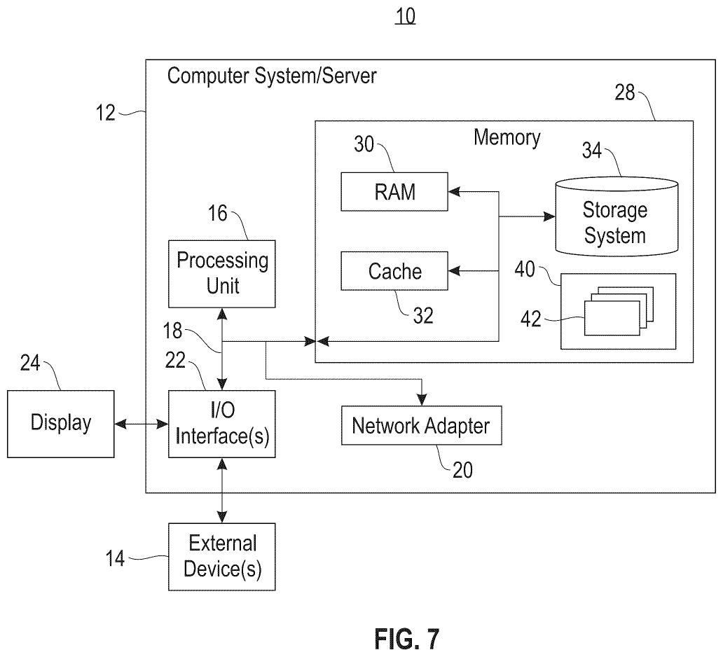

Referring now to FIG. 7, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below; memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for optimizing carbonization benefit based on sustainability design principles, the method comprising:
reading a plurality of sustainability design principles associated with an organization;
assigning each sustainability design principle of the plurality of sustainability design principles to one of a plurality of IT categories;
computing, based on the design principles assigned to each IT category, a percentage carbon footprint for each of the plurality of sustainability design principles and for each of the IT categories;
selecting, based on the computed percentage carbon footprints for each of the IT categories, a most impactful IT category;
generating a sorted priority list of sustainability design principles within the most impactful IT category; and
recommending an action plan to maximize carbonization benefit to the organization based on the sorted priority list of carbon footprint savings.

2. The method of claim 1, wherein each IT category corresponds to one of compute, network, or storage.

3. The method of claim 1, wherein selecting the most impactful IT category comprises:
measuring a footprint of resources for the organization;
determining for each IT category, from the footprint of resources, a percentage of carbon emission associated with each design principle within the IT category; and
determining a maximum benefit of carbon improvement for each IT category.

4. The method of claim 3, wherein determining a maximum benefit of carbon improvement comprises determining a historical pattern of carbon improvement.

5. The method of claim 1, further comprising determining an energy savings value for each sustainability design principle.

6. The method of claim 1, wherein generating a sorted priority list of carbon footprint savings within the most impactful IT category comprises:
determining a carbon footprint savings based on a historical trend of each sustainability design principle; and
creating a decreasing list of carbon footprint savings associated with each sustainability design principle.

7. The method of claim 1, further comprising:
determining one or more workload characteristics associated with each sustainability design principle;
projecting, based on the one or more workload characteristics, a future energy consumption value for each sustainability design principle.

8. The method of claim 7, wherein the one or more workload characteristics comprise one or more of a high compute intensive workload, a high input/output intensive workload, and/or a memory intensive workload.

9. The method of claim 7, further comprising:
determining one or more alternative feasible options to each sustainability design principle;
generating a future energy consumption value for each of the one or more alternative feasible options;
comparing the future energy consumption value of each of the one or more alternative feasible options with the future energy consumption value for each sustainability design principle.

10. The method of claim 9, further comprising generating a recommendation based on the comparing the one or more alternative feasible options with the sustainability design principle.

11. The method of claim 9, wherein the one or more alternative feasible options comprises a smart hardware option, a storage option, or a network equipment option.

12. The method of claim 1, further comprising determining an energy saving metric derived from a historical behavior of resource consumption.

13. The method of claim 12, wherein historical behavior of resource consumption is based on trends and patterns based on historical data.

14. The method of claim 13, wherein selecting the most impactful bucket of the plurality of IT categories is based on the historical behavior of resource consumption.

15. The method of claim 1, further comprising:
generating a statistical model of the carbon footprint of each sustainability design principle; and
determining an infrastructure provision decision based on the statistical model.

16. The method of claim 15, further comprising verifying the infrastructure provision decision by comparing infrastructure options.

17. A system for optimizing carbonization benefit based on sustainability design principles, the system comprising:
a computing node comprising a computer readable storage medium having program instructions embodied therewith, the program instructions executable by a processor of the computing node to cause the processor to perform a method comprising:
reading a plurality of sustainability design principles associated with an organization;
assigning each sustainability design principle of the plurality of sustainability design principles to one of a plurality of IT categories;
computing, based on the design principles assigned to each IT category, a percentage carbon footprint for each of the plurality of sustainability design principles and for each of the IT categories;
selecting, based on the computed percentage carbon footprints for each of the IT categories, a most impactful IT category;
generating a sorted priority list of sustainability design principles within the most impactful IT category; and
recommending an action plan to maximize carbonization benefit to the organization based on the sorted priority list of carbon footprint savings.

18. The system of claim 17, wherein each IT category corresponds to one of compute, network, or storage.

19. The system of claim 17, wherein selecting the most impactful IT category comprises:
measuring a footprint of resources for the organization;
determining for each bucket, from the footprint of resources, a percentage of carbon emission associated with each design principle within the IT category; and
determining a maximum benefit of carbon improvement for each IT category.

20. A computer program product for optimizing carbonization benefit based on sustainability design principles, the computer program product comprising a computer readable storage medium having program instructions embodied therewith, the program instructions executable by a processor to cause the processor to perform a method comprising:
reading a plurality of sustainability design principles associated with an organization;
assigning each sustainability design principle of the plurality of sustainability design principles to one of a plurality of IT categories;
computing, based on the design principles assigned to each IT category, a percentage carbon footprint for each of the plurality of sustainability design principles and for each of the IT categories;
selecting, based on the computed percentage carbon footprints for each of the IT categories, a most impactful IT category;
generating a sorted priority list of sustainability design principles within the most impactful IT category; and
recommending an action plan to maximize carbonization benefit to the organization based on the sorted priority list of carbon footprint savings.
